(19) United States
(12) Patent Application Publication
(10) Pub. No.: US 2026/0251533 A1
(43) Pub. Date: Aug. 27, 2026

(54) TEST METHOD AND SYSTEM FOR HIGH-SPEED IMPACT OF FOREIGN OBJECT ON RAIL VEHICLE COMPONENT IN LOW-TEMPERATURE ENVIRONMENT

(71) Applicant: CENTRAL SOUTH UNIVERSITY, Changsha (CN)

(72) Inventors: Zhonggang WANG, Changsha (CN); Xinxin WANG, Changsha (CN); Wei XIONG, Changsha (CN); Zhendong LI, Changsha (CN); Kai LIU, Changsha (CN); Ke YUAN, Changsha (CN); Shengwen YIN, Changsha (CN); Junjie DENG, Changsha (CN); Lejiang WANG, Changsha (CN)

(21) Appl. No.: 19/534,688

(22) Filed: Feb. 9, 2026

(30) Foreign Application Priority Data
Feb. 21, 2025 (CN) 202510197638 .7
Feb. 21, 2025 (CN) 202510197640 .4

(51) Int. Cl. G01M 17/08

(52) U.S. Cl. CPC G01M 17/08

(57) ABSTRACT

Disclosed are a test method and system for high-speed impact of a foreign object on a rail vehicle component in a low-temperature environment. The system includes a rapid cooling environmental chamber, a self-pressurizing liquid nitrogen tank, a high-pressure air cannon system, and a strain collection system. Rapid cooling is implemented through a liquid nitrogen condensation pipe, and a multi-angle impact test is completed through a rotating support seat and an adjustable-position sliding mechanism. A disposable low-strength sealing thermal insulation film is used to reduce heat exchange and improve test accuracy. An environmental temperature and humidity sensor is integrated with a built-in sensor of a to-be-tested component to implement temperature and humidity coupled monitoring. A cooling structure is arranged outside a barrel of the high-pressure air cannon system, and the strain collection system can synchronously complete high-speed camera shooting and strain and speed data collection.

### TECHNICAL FIELD

The present disclosure belongs to the field of high-speed impact tests of foreign objects on rail vehicle components, and particularly relates to a test method and system for high-speed impact of a foreign object on a rail vehicle component in a low-temperature environment.

### BACKGROUND

With the rapid development of rail vehicle technologies, all kinds of trains generally face risks of high-speed impact of falling rocks, hail, ballast and other foreign objects in operation, which seriously threaten driving safety. In order to ensure sufficient impact resistance of structural components of vehicle bodies, it is necessary to perform high-speed impact tests of foreign objects on various components and materials of rail vehicles with different severities. At present, such impact tests are generally performed in a room-temperature environment in a laboratory. However, in many regions of the world, especially in high-latitude countries and cold regions (such as northern Europe), extremely-low-temperature weather occurs frequently. At low temperature, materials of vehicle bodies will undergo obvious ductile-brittle transition, leading to a significant decline in impact resistance. Thus, it has become a key technical requirement to perform a high-speed impact test of a foreign object on a rail vehicle component, which can simulate an extremely-low-temperature environment, to ensure safe operation of a train in various cold conditions around the world. For low-temperature environment simulation, some solutions have been put forward in the prior art, including constructing a closed test environment integrated with a refrigeration function, and maintaining a low-temperature environment in an impact process through mechanical sealing.

Although existing technologies have made some progress in the low-temperature environment simulation, they still have obvious technical defects, thus failing to satisfy complex requirements of an actual engineering test of a rail vehicle component. With the Chinese patent CN111157370A as an example, its disclosed “Low-temperature crash test environmental chamber for vehicle body part and test method thereof” represents a typical implementation in the prior art. The technical solution can provide a basic low-temperature test environment, and has the following key problems in practical application:

A test angle is single, such that a real multi-angle impact scene cannot be simulated. Specifically, an impact head apparatus in the solution of the prior art is fixed, and only a single-angle impact test can be implemented. In actual operation, a rail vehicle component may be impacted by foreign objects from different orientations and angles, such as hail at a certain entrance angle. A single-angle test mode in the prior art is seriously inconsistent with a real complex impact working condition, such that test results cannot truly reflect impact resistance of the component in an actual service environment.

Accurate and balanced monitoring and control of a state of a to-be-tested component are lacking. Specifically, the solution does not involve monitoring and balanced control of internal temperature and humidity states of the to-be-tested component in a test process. In a rapid cooling process, a temperature gradient and a humidity difference can easily be produced between an interior and a surface of the to-be-tested component and between different parts of the to-be-tested component. If the to-be-tested component is impacted before reaching a uniform and stable predetermined low-temperature state, its material properties do not truly reflect its characteristics at a target test temperature. This leads to distortion of test data, such that a ductile-brittle transition behavior and impact resistance of a material in a uniform low-temperature environment cannot be accurately evaluated.

Based on the current situation of the prior art, various technical solutions for overcoming the above defects generally have the following inherent defects:

The solutions have rigid functions and poor adaptability. Specifically, most of the existing solutions use a rigid connection mode between a fixed impact apparatus and an environmental chamber, without a function of flexibly adjusting an entrance angle of impact according to test requirements. This means that every time a new-angle test is performed, complex transformation or redesign of hardware may be needed, which is inefficient and costly.

Condition monitoring is lacking, and test accuracy is not ensured. Specifically, most of the existing solutions focus on overall temperature control of an environmental cavity, and generally lack a direct and multi-point monitoring method for an internal temperature and humidity field of a core test object of a to-be-tested component body. The “black box” temperature control method cannot ensure uniformity and representativeness of material properties of the to-be-tested component at the moment of impact, making it difficult to ensure reliability and accuracy of the test results.

Low system integration and insufficient authenticity are caused. Specifically, the existing technical solutions generally regard the environmental chamber and an impact system as relatively independent units, without considering a temperature state of an impact object (for example, simulated hail and stones) before launching. In a real low-temperature environment, the impact object is also in a low-temperature state. In the prior art, the impact object is not cooled synchronously, which leads to an unreal physical scene that a “hot” impact object impacts a “cold” to-be-tested component at the moment of impact. This situation influences authenticity of energy transfer and damage mode simulation.

In view of that, there is an urgent need in the field for a test method and system for high-speed impact of a foreign object on a rail vehicle component, which can implement multi-angle adjustment, accurately and synchronously control and monitor temperatures and humidities of a to-be-tested component and an impact object, and efficiently simulate an extremely-low-temperature environment, so as to fill the gaps in the prior art and satisfy the increasingly stringent safety test requirements of global rail transit.

### SUMMARY

The present disclosure aims to overcome defects of an existing test system for high-speed impact on a rail vehicle component in the aspects of rapid low-temperature environment construction, multi-angle test simulation, accurate to-be-tested component temperature and humidity monitoring, and impact object low-temperature maintenance, and provides a test method and system for high-speed impact of a foreign object on a rail vehicle component in a low-temperature environment, which integrate rapid cooling, multi-angle adjustment, accurate testing, and synchronous impact control. The core lies in that an extremely-low-temperature test condition is rapidly and stably constructed in a normal-temperature environment by cooling through combination and cooperation of a rotating adjustable impact mechanism, a liquid nitrogen rapid cooling and intelligent temperature control unit, and a barrel-environmental chamber, and different impact angles can be flexibly set to simulate a real working condition of a to-be-tested component, such that key technical equipment support can be provided for impact resistance evaluation and safety design verification of the rail vehicle component in a cold environment.

In order to solve the above problems, a first aspect of the present disclosure provides a test system for high-speed impact of a foreign object on a rail vehicle component in a low-temperature environment. The system includes: a rapid cooling environmental chamber, configured to provide a low-temperature test environment and accommodate a to-be-tested component, where one side surface of the rapid cooling environmental chamber is provided with an openable and closable impact object entrance door, a liquid nitrogen condensation pipe is laid on inner walls of the other side surfaces of the rapid cooling environmental chamber, and the impact object entrance door is provided with an impact object entrance port; a self-pressurizing liquid nitrogen tank, connected to the liquid nitrogen condensation pipe through a conveying pipeline, and configured to provide a cooling medium for the rapid cooling environmental chamber; a high-pressure air cannon system, configured to provide a power source for an impact object, including an air cannon, an air compressor connected to the air cannon, a projectile compartment arranged on the air cannon, and a barrel connected to the projectile compartment, where one end of an outlet of the barrel is provided with a velocimeter, and during use, the outlet of the barrel is configured to be aligned with the impact object entrance port; a strain collection system, configured to collect a strain response of an impact zone, including a high-speed camera, an environmental temperature and humidity sensor, and to-be-tested component temperature and humidity sensors, where the high-speed camera is mounted on a pre-mounted connector on a wall surface of the rapid cooling environmental chamber, and configured to capture an impact process; the to-be-tested component temperature and humidity sensors are embedded in the to-be-tested component, and configured to monitor temperature and humidity parameters of the to-be-tested component; and the environmental temperature and humidity sensor is arranged in the rapid cooling environmental chamber, and configured to monitor temperature and humidity parameters in the rapid cooling environmental chamber; and a microcomputer system, connected to the strain collection system in a communicating manner, and configured to perform centralized processing, storage and analysis on data collected by the strain collection system, and control the high-pressure air cannon system, the rapid cooling environmental chamber and the self-pressurizing liquid nitrogen tank to work cooperatively, so as to complete a complete test flow from environmental cooling and impact launching to data collecting.

The core of the test system for high-speed impact of a foreign object on a rail vehicle component in a low-temperature environment according to the present disclosure is implementation through specific connections and cooperative work of the rapid cooling environmental chamber, the self-pressurizing liquid nitrogen tank, the high-pressure air cannon system, and the strain collection system. The system performs thermal-insulation accommodation and temperature and humidity control on the to-be-tested component through the rapid cooling environmental chamber, and adjusts a test angle through a rotating support seat. The self-pressurizing liquid nitrogen tank provides cooling media for the liquid nitrogen condensation pipe laid on an inner wall of a chamber body and a barrel liquid nitrogen condensation pipe wound around the barrel of the high-pressure air cannon system, thus implementing synchronous low-temperature treatment of a test environment and the impact object. The high-pressure air cannon system launches the impact object at a predetermined angle, and monitors an impact speed through the velocimeter. The strain collection system collects the strain response and image data in the impact process. The rapid cooling environmental chamber, the self-pressurizing liquid nitrogen tank, the high-pressure air cannon system and the strain collection system are connected to a data collection interface for cooperation through a control unit. Through connection and cooperation of the above components, the system implements a multi-angle high-speed impact test and comprehensive data collection of the rail vehicle component in the low-temperature environment that is accurately controllable.

Further, the rapid cooling environmental chamber includes: a chamber body, including a framework and a sandwich thermal insulation wall surface formed by a high-strength aluminum alloy plate and a thermal insulation material, where an inner wall of the chamber body is provided with a to-be-tested component fixed mounting fixture and a humidity regulator; and a rotating support seat, arranged at a bottom of the chamber body, and configured to adjust a rotation angle of the chamber body. The rotating support seat includes a fixed end and a rotating end. The fixed end is hinged to the rotating end. The rotating end is locked after rotating by a predetermined angle.

Further, the impact object entrance door is movably connected to the framework. The chamber body is sealed when the impact object entrance door is closed, and the to-be-tested component is placed in the chamber body after the impact object entrance door is opened. The impact object entrance door is provided with an adjustable-position sliding mechanism. Left and right sides of the adjustable-position sliding mechanism are connected to stretchable parts. The adjustable-position sliding mechanism is provided with a disposable low-strength sealing thermal insulation film. The impact object entrance port is located in a zone of the disposable low-strength sealing thermal insulation film. A moving distance of the impact object entrance port is

$$L = \frac{H}{tan θ} .$$

H denotes a perpendicular distance from an impact point position of the to-be-tested component to a plane of the impact object entrance port. θ denotes an entrance angle.

Further, the rotating support seat further includes a central hinge pin. The fixed end is hinged to the rotating end through the central hinge pin. A rotational degree of freedom of the rotating end is 0° to 75°. The rotating end is carried by a universal wheel. The central hinge pin is provided with a bolt fastening apparatus. The bolt fastening apparatus is configured to lock the rotating end. The central hinge pin is provided with an angle scaleplate.

Further, the disposable low-strength sealing thermal insulation film is made of a flexible material, and is bonded to the impact object entrance port through glue. A thickness of the disposable low-strength sealing thermal insulation film is 0.1 mm to 2 mm. The material has breaking strength not higher than 0.1 MPa and an elongation not greater than 10%. The disposable low-strength sealing thermal insulation film is provided with a cross-shaped center mark. The stretchable parts are corrugated origami structures made of flexible thermal insulation materials.

Further, an inner wall surface of the chamber body is provided with a collection harness connector configured to connect the environmental temperature and humidity sensor, a strain gauge, and an auxiliary test sensor. The collection harness connector is externally connected to a temperature and humidity processing unit. The temperature and humidity processing unit is connected to the environmental temperature and humidity sensor and the to-be-tested component temperature and humidity sensors, and is configured to monitor a temperature and humidity difference between an environment in the chamber body and the to-be-tested component. An outlet of the self-pressurizing liquid nitrogen tank is provided with an intelligent liquid nitrogen flow control valve. A liquid nitrogen flow amount is regulated in real time by receiving temperature data of the temperature and humidity processing unit. When a temperature difference and a humidity difference between the environment in the chamber body and the to-be-tested component are ±1° C. and 2%, respectively, it is determined that a temperature and humidity of the to-be-tested component are consistent with those of the environment. In a cooling process, a maximum temperature difference and a maximum humidity percentage difference between the to-be-tested component and the environment in the chamber body are less than 10° C. and 10%, respectively.

Further, a quantity of the to-be-tested component temperature and humidity sensors is not less than 4. The to-be-tested component temperature and humidity sensors are arranged at different positions of the to-be-tested component, respectively. If a relative error of temperature and humidity data monitored at different positions is within 2%, it is determined that the to-be-tested component reaches a stable test state.

Further, a barrel liquid nitrogen condensation pipe is spirally wound around an outer surface of the barrel of the high-pressure air cannon system. The barrel liquid nitrogen condensation pipe is connected to the self-pressurizing liquid nitrogen tank. The outer surface of the barrel is provided with a pipeline temperature and humidity sensor. The pipeline temperature and humidity sensor makes no direct contact with the barrel liquid nitrogen condensation pipe.

Further, the barrel of the high-pressure air cannon system and the impact object are mounted in a matched manner through a separable projectile holder. The separable projectile holder has a shape of 4 to 6 equal petals, an outer contour in clearance fit with an interior of the barrel, and a fit tolerance of 0.1 mm to 0.3 mm. The separable projectile holder is made of a light foaming material, and has a mass less than 20 g.

According to another aspect of the present disclosure, the present disclosure further provides a test method for high-speed impact of a foreign object on a rail vehicle component in a low-temperature environment, which uses the above test system. The method includes the following steps: opening an impact object entrance door in a rapid cooling environmental chamber, mounting a to-be-tested component on a to-be-tested component fixed mounting fixture to be locked and fixed, connecting signal wires of all sensors to a collection harness connector on a side wall surface of the rapid cooling environmental chamber, and then locking the impact object entrance door; adjusting an angle of a chamber body through a rotating support seat, and then moving stretchable parts to adjust a center of an impact object entrance port to a predetermined position; setting temperature and humidity parameters of an environment, and starting a cooling and humidity regulation program to satisfy test requirements; placing an impact object in a projectile compartment to be sealed, and turning on an air compressor to inject compressed air into a pressure chamber until an air pressure reaches a rated value; aligning an outlet of the barrel with the center of the impact object entrance port of the chamber body; and launching the impact object, accelerating the impact object through a barrel under a pushing action of high-pressure gas until the impact object hits the to-be-tested component, and meanwhile, causing a velocimeter and a strain collection system to start to work and obtain all test data of an impact process of the to-be-tested component synchronously. The velocimeter and the strain collection system are started synchronously through activation of start signals of a solenoid valve, with a response delay within 1 ms.

The above technical solution of the present disclosure has the following beneficial technical effects:

In the test method and system for high-speed impact of a foreign object on a rail vehicle component in a low-temperature environment according to the present disclosure, the high-speed impact test on a to-be-tested component at different angles in the low-temperature environment is implemented through the rotatable rapid cooling environmental chamber, which is more in line with requirements of practical application scenes of engineering. The disposable low-strength sealing thermal insulation film greatly reduces heat/moisture exchange between an interior of the chamber body of the rapid cooling environmental chamber and an external environment, and ensures stability of the test environment, thus improving test accuracy and greatly reducing test refrigeration cost. The temperature and humidity data of the to-be-tested component and temperature and humidity data of the environment in the chamber body are coupled to be monitored, such that a state of the environment in the rapid cooling environmental chamber is more accurately regulated and controlled, and a state of the to-be-tested component is ensured to be true and effective. Meanwhile, the test system integrates a launching system with various external monitoring apparatuses, which can implement millisecond-class collection immediately after triggering, thus ensuring consistency of a data time dimension, and reducing data processing errors. The test system can implement the test environment of −150° C. and satisfy test requirements of materials and components in various fields in an extremely cold environment. Specifically, an angle of the chamber body can be flexibly regulated by mounting the rotating support seat at the bottom of the chamber body. The impact object entrance door is provided with the adjustable-position sliding mechanism and a scaleplate, and the left and right sides of the adjustable-position sliding mechanism are connected to the stretchable parts. In this way, the adjustable-position sliding mechanism can horizontally move on the impact object entrance door, and the moving distance can be rapidly and accurately adjusted through an entrance angle value and the perpendicular distance of impact of the to-be-tested component, thus ensuring accuracy of deflected-angle impact. The adjustable-position sliding mechanism is provided with the disposable low-strength sealing thermal insulation film, which not only implements sealing and thermal insulation of the rapid cooling environmental chamber, but also minimizes energy loss caused by impact of the foreign object and secondary damage of chips to the to-be-tested component. The disposable low-strength sealing thermal insulation film is provided with the cross-shaped center mark, facilitating alignment and checking of the impact object, the impact object entrance port, and an entrance point before the test. The impact object entrance port is located in the zone of the disposable low-strength sealing thermal insulation film. The adjustable-position sliding mechanism can perform displacement and adjustment on the impact object entrance door, such that a position of the impact object entrance port is adjustable. The disposable low-strength sealing thermal insulation film is replaced after one test, such that rapid cooling in the chamber body of the rapid cooling environmental chamber can be ensured, and a temperature of the low-temperature environment can be accurately controlled. The temperature and humidity processing unit regulates and controls temperatures and humidities of the environment in the chamber body and the to-be-tested component, such that an actual temperature of the to-be-tested component is ensured to be consistent with the temperature of the environment, and test accuracy is improved. In addition, the liquid nitrogen condensation pipe and the environmental temperature and humidity sensor are laid on an inner side wall surface (excluding the impact object entrance door) of the chamber body of the rapid cooling environmental chamber, and the liquid nitrogen condensation pipe is connected to the self-pressurizing liquid nitrogen tank through an external channel of the rapid cooling environmental chamber. In this way, the low-temperature environment can be implemented efficiently and conveniently.

### BRIEF DESCRIPTION OF THE DRAWINGS

FIG. 1 is a schematic structural diagram of a test system for high-speed impact of a foreign object on a rail vehicle component in a low-temperature environment in an embodiment of the present disclosure.

FIG. 2 is a schematic structural diagram of a rapid cooling environmental chamber in an embodiment of the present disclosure.

FIG. 3 is a schematic structural diagram of a rapid cooling environmental chamber in another state in an embodiment of the present disclosure.

FIG. 4 is a schematic structural diagram of a to-be-tested component in an embodiment of the present disclosure.

FIG. 5 is a flowchart of a test method for high-speed impact of a foreign object on a rail vehicle component in a low-temperature environment in an embodiment of the present disclosure.

### REFERENCE NUMERALS

100: rapid cooling environmental chamber; 200: self-pressurizing liquid nitrogen tank; 300: high-pressure air cannon system; 400: velocimeter; 500: strain collection system; 600: high-speed camera; 700: microcomputer system; 1: rotating support seat; 11: rotating end; 12: fixed end; 13: universal wheel; 14: bolt fastening apparatus; 15: angle scaleplate; 2: high-speed camera; 3: chamber body; 31: wall surface; 32: framework; 33: collection harness connector; 4: high-speed camera observation port; 41: protective glass cover; 5: illumination device; 6: liquid nitrogen condensation pipe; 61: liquid nitrogen condensation pipe main connector (external channel); 7: impact object entrance door; 71: adjustable-position sliding mechanism; 711: stretchable part; 72: environmental temperature and humidity sensor; 73: inclined high-speed camera mounting hole; 74: disposable low-strength sealing thermal insulation film; 75: impact object entrance port; 8: to-be-tested component fixed mounting fixture; 9: to-be-tested component; 91: to-be-tested component temperature and humidity sensor; 92: collection harness; 10: humidity regulator; 102: temperature and humidity processing unit; 103: refrigerant conveying channel; 104: intelligent liquid nitrogen flow control valve; 105: data transmission line; 310: air cannon; 301: air compressor; 302: projectile compartment; 303: barrel; 303-1: barrel liquid nitrogen condensation pipe; 303-2: thermal insulation layer; and 304: barrel fixing support.

### DETAILED DESCRIPTIONS OF THE EMBODIMENTS

For making objectives, technical solutions and advantages of the present disclosure clearer, the present disclosure will be further described in detail below in conjunction with the specific implementations with reference to accompanying drawings. It should be understood that the description is merely illustrative, and is not intended to limit the scope of the present disclosure. Further, the description of well-known structures and technologies is omitted in the following description, such that concepts of the present disclosure are prevented from being unnecessarily confused.

In order to solve the above problems in the prior art, the present disclosure provides a test method and system for high-speed impact of a foreign object on a rail vehicle component in a low-temperature environment. Through the system, a multi-angle high-speed impact test on the rail vehicle component can be implemented under a simulated low-temperature environmental condition, and authenticity and effectiveness of test results are ensured through accurate temperature and humidity control and synchronous data collection. When the system works, a to-be-tested component is cooled rapidly and uniformly in a rapid cooling environmental chamber through a liquid nitrogen condensation system, and accurate positioning of different impact angles is implemented by combining a rotating support seat and an adjustable-position sliding mechanism. An impact object is launched by a high-pressure air cannon system, and a cooling structure outside a barrel ensures temperature consistency between the impact object and a test environment. Temperature and humidity sensors are integrated to monitor an environment of a chamber body and an internal state of the to-be-tested component, and a strain collection system synchronously records a strain, a speed and image data of an impact process. Through a technology of rapid cooling, multi-angle adjustment and multi-sensor integration, the solution avoids problems of a single angle, a temperature and humidity mismatch and asynchronous data in a conventional low-temperature impact test, and finally achieves accurate controllability and reliable data of a multi-angle impact test in an extremely-low-temperature environment, providing a complete and effective test platform for evaluation of impact resistance of the rail vehicle component under extremely cold conditions.

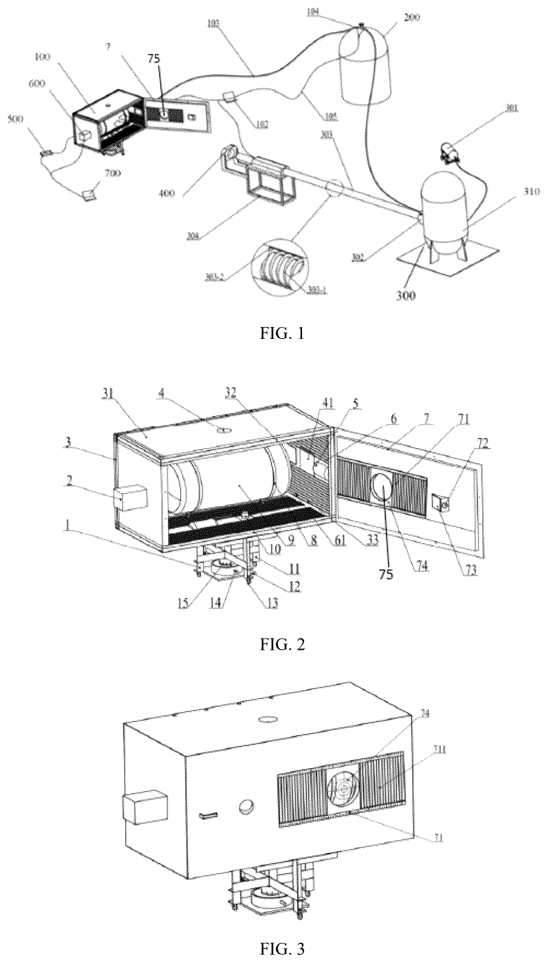

In combination with FIG. 1 to FIG. 4, a test method and system for high-speed impact of a foreign object on a rail vehicle component in a low-temperature environment according to the present disclosure will be described below.

FIG. 1 is a schematic structural diagram of a test system for high-speed impact of a foreign object on a rail vehicle component in a low-temperature environment in an embodiment of the present disclosure.

As shown in FIG. 1, the embodiment provides a test system for high-speed impact of a foreign object on a rail vehicle component in a low-temperature environment. The system includes a rapid cooling environmental chamber 100, a self-pressurizing liquid nitrogen tank 200, a high-pressure air cannon system 300, a strain collection system 500, and a microcomputer system 700. Through an integrated and adjustable design, the system implements a multi-angle and high-precision impact test and synchronous data collection of a to-be-tested component under extremely-low-temperature conditions, such that problems of a single angle, inaccurate temperature and humidity control and asynchronous data collection in conventional test methods are effectively solved.

The rapid cooling environmental chamber 100 provides and maintains a low-temperature environment required by a test. One side surface of the rapid cooling environmental chamber is provided with an openable and closable impact object entrance door 7. The impact object entrance door is provided with an impact object entrance port 75. A liquid nitrogen condensation pipe 6 is laid on inner walls of the other side surfaces of the rapid cooling environmental chamber. The liquid nitrogen condensation pipe 6 is connected to the self-pressurizing liquid nitrogen tank 200 through a conveying pipeline to form a cooling medium supply passage. In this way, rapid cooling of the rapid cooling environmental chamber 100 is implemented. Meanwhile, an intelligent liquid nitrogen flow control valve 104 automatically regulates a flow amount of liquid nitrogen flowing to the rapid cooling environmental chamber in real time according to temperature data from a temperature and humidity processing unit 102, so as to implement closed-loop temperature control of an environment of a chamber body. An environmental temperature and humidity sensor arranged in the rapid cooling environmental chamber and to-be-tested component temperature and humidity sensors embedded in a to-be-tested component are configured to collect state data of the environment and the to-be-tested component in real time, respectively.

The high-pressure air cannon system 300 includes an air cannon 310, an air compressor 301 connected to the air cannon 310, a projectile compartment 302 arranged on the air cannon 310, and a barrel 303 connected to the projectile compartment 302. One end of an outlet of the barrel 303 is provided with a velocimeter 400. More specifically, the high-pressure air cannon system 300 is started under the control of a solenoid valve, and the air compressor 301 stores the compressed air in a pressure chamber through an air pipe, with a maximum bearable pressure of 3 MPa. The pressure chamber is connected to the solenoid valve. A top of the projectile compartment 302 is provided with an openable sealing cover plate, facilitating placement of an impact object. One end of the projectile compartment 302 is connected to the barrel 303. When the solenoid valve is opened, high-pressure gas pushes the impact object to accelerate in the barrel 303 and finally flies out of the outlet of the barrel and rushes to the to-be-tested component in the rapid cooling environmental chamber 100. During the test, the outlet of the barrel of the high-pressure air cannon system 300 is accurately aligned with the impact object entrance port 75 on the chamber body, and the velocimeter monitors and analyzes a speed of the impact object in real time.

Meanwhile, a high-speed camera in the strain collection system 500 captures all shapes of an impact position of the to-be-tested component in an impact damage process from the moment of impact. A maximum sampling frequency of the high-speed camera 600 is 50,000 frames/second. The strain collection system 500 is connected to a collection harness connector arranged on a wall surface of the rapid cooling environmental chamber 100 through a signal transmission line. The strain collection system 500 is preferably 16 channels with a maximum sampling frequency of 500,000 Hz. The velocimeter 400 is mounted in front of the outlet of the barrel, and determines a speed by measuring passing time of the impact object through laser pulse intervals, with a speed measurement accuracy of =0.01 m/s. Startup programs of the high-pressure air cannon system 300, the velocimeter 400, the strain collection system 500 and the high-speed camera 600 are all linked to a control system of the microcomputer system through preconfigured programs. When the test system is started, the components are started synchronously through activation of start signals of the solenoid valve, with a response delay within 1 ms. Temperature and humidity data of the environment and the to-be-tested component collected by the strain collection system 500, image data of an impact process and velocimeter data are transmitted to the microcomputer system 700 through a communication link. The microcomputer system 700 performs centralized processing, storage and analysis on all data collected by the strain collection system 500, and controls the high-pressure air cannon system 300, the rapid cooling environmental chamber 100 and the self-pressurizing liquid nitrogen tank 200 to work cooperatively. In this way, strict correspondence of physical quantities in time dimension in the impact process is ensured, and a complete test flow and accurate evaluation from environmental cooling, impact launching to data collection are implemented.

Preferably, in the high-pressure air cannon system 300, a barrel liquid nitrogen condensation pipe 303-1 is spirally wound around an outer surface of the barrel 303. The barrel liquid nitrogen condensation pipe 303-1 is connected to the intelligent liquid nitrogen flow control valve 104 of the self-pressurizing liquid nitrogen tank 200 through a refrigerant conveying channel 103. The intelligent liquid nitrogen flow control valve 104 regulates a liquid nitrogen flow amount in real time by receiving the temperature data of the temperature and humidity processing unit 102, so as to actively precool the barrel 303 and the internal impact object before launching. The outer surface of the barrel 303 is provided with a pipeline temperature and humidity sensor. The sensor makes no direct contact with the barrel liquid nitrogen condensation pipe 303-1. A disposable low-strength sealing thermal insulation film is bonded to an end of the outlet of the barrel 303. A thermal insulation layer 303-2 is bonded to an outer side of the barrel liquid nitrogen condensation pipe 303-1 to reduce heat exchange between the barrel 303 and an external environment. The design cooperates with a cooling system of the rapid cooling environmental chamber 100 to construct a complete low-temperature environment covering a launching path of the impact object and a test target zone.

Preferably, in the high-pressure air cannon system 300, the barrel 303 and the impact object are mounted in a matched manner through a separable projectile holder. The separable projectile holder has a shape of 4 to 6 equal petals, an outer contour in clearance fit with an interior of the barrel 303, and a fit tolerance controlled within a range of 0.1 mm to 0.3 mm. A horn-shaped arc surface is arranged in the separable projectile holder. The separable projectile holder is made of a light foaming material, and has a mass less than or equal to 20 g. The separable projectile holder is launched from the barrel 303 and then instantly separated under air resistance, which can implement the high-speed impact test of impact foreign objects having different shapes. The design causes the projectile holder to provide effective sealing and guidance for the impact object in the barrel, and to be quickly separated from the impact object under the air resistance after leaving the barrel due to its petal-shaped structure and a light characteristic. In this way, a residual part of the projectile holder is prevented from disturbing the impact process or causing additional damage to the to-be-tested component, and purity and accuracy of the high-speed impact test are ensured.

FIG. 2 is a schematic structural diagram of a rapid cooling environmental chamber in an embodiment of the present disclosure.

As shown in FIG. 2, the embodiment further shows a specific structure of a rapid cooling environmental chamber 100. The rapid cooling environmental chamber includes a rotating support seat 1 and a chamber body 3. The rotating support seat 1 is arranged at a bottom of the chamber body 3 and configured to flexibly regulate a rotation angle of the chamber body, such that a multi-angle impact test is implemented, which is more in line with test requirements of impact in different directions in practical engineering application. The chamber body 3 includes a framework 32 and a sandwich thermal insulation wall surface formed by a high-strength aluminum alloy plate and a thermal insulation material. In this way, a desirable thermal insulation effect is achieved while structural strength is ensured, and stability of a low-temperature test environment is maintained favorably. An inner wall of the chamber body 3 is provided with a to-be-tested component fixed mounting fixture 8 and a humidity regulator 10. The to-be-tested component fixed mounting fixture 8 is configured to mount a to-be-tested component. The humidity regulator 10 may actively regulate a humidity in the rapid cooling environmental chamber. One side surface of the chamber body 3 is provided with an impact object entrance door 7. The impact object entrance door 7 is movably connected to the framework of the chamber body. The chamber body is sealed when the impact object entrance door is closed, and the to-be-tested component 9 is placed after the impact object entrance door is opened. The impact object entrance door 7 is provided with an adjustable-position sliding mechanism 71. The adjustable-position sliding mechanism 71 is provided with a scaleplate. A position of the impact object entrance port 75 can be horizontally adjusted, and a moving distance of the impact object entrance port can be accurately controlled. Through cooperation with the rotating support seat 1, an impact point position can be accurately aligned, thus effectively improving test accuracy. The inner wall of the chamber body 3 is further provided with a plurality of groups of mounting connectors of high-speed cameras 600 for mounting the high-speed cameras 600 having different viewing angles, so as to fully capture the impact process. A liquid nitrogen condensation pipe 6 and an environmental temperature and humidity sensor 72 are laid on inner wall surfaces 31 of the other side surfaces of the chamber body 3. The environmental temperature and humidity sensor 72 is configured to monitor a temperature and humidity in the chamber body 3. The liquid nitrogen condensation pipe 6 is connected to a self-pressurizing liquid nitrogen tank 200 through a liquid nitrogen condensation pipe main connector 61, so as to implement efficient conveying of a cooling medium and rapid cooling in the rapid cooling environmental chamber. The to-be-tested component 9 is mounted in the chamber body 3 through the to-be-tested component fixed mounting fixture 8, and to-be-tested component temperature and humidity sensors 91 are embedded in the to-be-tested component and configured to monitor a temperature state of the to-be-tested component in real time. The wall surface 31 of the chamber body 3 is provided with a collection harness connector 33, which is configured to connect the to-be-tested component temperature and humidity sensors 91, the environmental temperature and humidity sensor 72, a strain gauge and an auxiliary test sensor (sensors such as an acceleration sensor are arranged according to different requirements). By comparing data of the environmental temperature and humidity sensor 72 and the to-be-tested component temperature and humidity sensors 91, it can be ensured that temperatures of the to-be-tested component and the test environment are fully balanced, and that the to-be-tested component is impacted at a real low-temperature state, thus improving accuracy and reliability of test results.

Optionally, the impact object entrance door 7 has a completely openable structure, and the impact object entrance door 7 is connected to the framework 32 of the chamber body 3 through a hinge. In order to facilitate assembly/disassembly of the to-be-tested component 9 in the chamber body 3, a rotary-latch door lock is used to facilitate opening and closing.

Preferably, the strain gauge is uniformly and orthogonally distributed near an impact point position in a circumferential direction, with a distance of 30 mm to 100 mm from a center of an impact point. The collection harness connector 33 is externally connected to a temperature and humidity processing unit 102. The temperature and humidity processing unit 102 is connected to the environmental temperature and humidity sensor 72 and the to-be-tested component temperature and humidity sensors 91, and is configured to monitor a temperature and humidity difference between an environment in the chamber body 3 and the to-be-tested component 9. In a cooling process, it takes time to conduct a temperature of the environment in the chamber body 3 to the to-be-tested component 9. Thus, temperatures of the environment in the chamber body and the to-be-tested component are detected at the same time, and a maximum temperature difference and a maximum humidity percentage difference between the to-be-tested component 9 and the environment in the chamber body 3 are controlled to be less than 10° C. and 10%, respectively, such that local deformation or failure of the to-be-tested component caused by rapid cooling of the temperature of the environment is prevented from influencing test accuracy.

Preferably, when the maximum temperature difference and the humidity percentage difference between the to-be-tested component 9 and the environment in the chamber body 3 are 1° C. and 2%, respectively, it is determined that the temperature and humidity of the to-be-tested component 9 are consistent with those of the environment, that is, preset temperature and humidity conditions are satisfied. In a process of temperature control, in a control logic, a priority of the temperature of the to-be-tested component 9 is higher than that of the temperature of the environment in the chamber body 3, so as to ensure that the temperature of the to-be-tested component 9 reaches a standard.

Preferably, when the to-be-tested component 9 has a large area or a complicated shape, a quantity of the to-be-tested component temperature and humidity sensors 91 is not less than 4. The to-be-tested component temperature and humidity sensors are arranged at different positions of the to-be-tested component 9, respectively. If a relative error of data monitored at different monitoring positions is within 2%, it may be determined that the to-be-tested component 9 reaches a stable test state.

Preferably, the liquid nitrogen condensation pipe 6 is a stainless steel pipe with a diameter of 3 mm to 6 mm. The liquid nitrogen condensation pipes are distributed in an S-shape along all inner wall surfaces of the chamber body 3 and finally gather at the liquid nitrogen condensation pipe main connector 61 to be connected to the self-pressurizing liquid nitrogen tank 200.

Preferably, a layout of the liquid nitrogen condensation pipe 6 on each wall surface is optimized through a thermo-fluid coupling analysis technology, and a maximum cooling rate can reach 20° C./min, such that a heat exchange efficiency and rate of the liquid nitrogen condensation pipe 6 can be greatly improved, an amount of liquid nitrogen can be reduced, and test cost can be reduced.

Preferably, the self-pressurizing liquid nitrogen tank 200 is connected to an external channel of the liquid nitrogen condensation pipe 6 of the rapid cooling environmental chamber 100 through a low-temperature resistant pipeline, with a maximum volume of 200 L. 2 intelligent liquid nitrogen flow control valves 104 are arranged at an interface between the self-pressurizing liquid nitrogen tank and the external channel, and are in communication with the rapid cooling environmental chamber 100 and the interface of the liquid nitrogen condensation pipe, respectively. The intelligent liquid nitrogen flow control valves 104 are connected to the temperature and humidity processing unit 102 through a data transmission line 105. A liquid nitrogen flow amount can be regulated and controlled in 0 L/min to 10 L/min in a stepless manner, and regulation and control accuracy can reach ±0.05 L/min. Temperature changes in the chamber body and the barrel of the air cannon can be regulated by controlling the liquid nitrogen flow amount in real time through reception of program-controlled data of the temperature and humidity processing unit 102. The liquid nitrogen flow amount is automatically regulated in real time through reception of data of the environmental temperature and humidity sensor 72 of the chamber body 3, such that the temperature in the chamber body 3 can be reduced and controlled stably, and temperature control accuracy is ±0.5° C.

Before a predetermined stable test temperature and humidity are not reached in the environment in the chamber body 3 (cooling stage), the temperature and humidity processing unit 102 is connected to the intelligent liquid nitrogen flow control valve 104 and the humidity regulator 10 for regulation and controlling. The maximum temperature difference and the maximum humidity percentage difference between the to-be-tested component 9 and the environment in the chamber body 3 are less than 10° C. and 10%, respectively, which ensures stability and accuracy of test results. Liquid nitrogen is used as a cooling medium, which can not only greatly improve cooling efficiency of the test, but also significantly reduce test cost, so as to be more suitable for a low-temperature safety protection test of the rail vehicle component.

Preferably, the external liquid nitrogen is guided into the chamber body through a pipeline in a non-circulating cooling mode for heat exchange and then flows out, and a minimum environmental temperature can reach 150° C., such that an extremely-low-temperature environmental requirement of the rail vehicle component can be fully satisfied, and the test cost can be greatly reduced.

Meanwhile, in the test system for high-speed impact of a foreign object on a rail vehicle component in a low-temperature environment according to the present disclosure, the high-speed impact test on a to-be-tested component at different angles in the low-temperature environment is implemented through the rotatable chamber body 3, which is more in line with requirements of practical application scenes of engineering. Specifically, the rotating support seat 1 is mounted at the bottom of the chamber body 3. The rotating support seat 1 includes a fixed end 12 and a rotating end 11. The fixed end 12 is fixed to the ground, and the fixed end 12 is hinged to the rotating end 11. A rotational degree of freedom of the rotating end 11 is 0° to 75°. When in use, after a required entrance angle of the to-be-tested component is determined, the rotating end 11 is rotated by a predetermined angle and locked, such that the chamber body 3 can be adjusted and fixed within a range of 0° to 75°, so as to satisfy multi-angle impact test requirements.

Preferably, the fixed end 12 of the rotating support seat 1 is hinged to the rotating end 11 through a central hinge pin, and the rotating end 11 is carried by a universal wheel 13 to ensure the rotational degree of freedom of the rotating end around the central hinge pin. The central hinge pin of the rotating support seat 1 is provided with a bolt fastening apparatus 14. The bolt fastening apparatus 14 is configured to lock the rotating end 11 to ensure that the rotating end 11 of the rotating support seat 1 cannot rotate around the central hinge pin in a locked state. The central hinge pin of the rotating support seat 1 is provided with an angle scaleplate 15. The angle scaleplate 15 may quickly and accurately determine a rotation angle. When in use, the bolt fastening apparatus 14 of the central hinge pin and the universal wheel 13 of the rotating support seat are unlocked, then the entrance angle is adjusted, and finally the universal wheel 13 and the bolt fastening apparatus 14 of the central hinge pin are locked, so as to ensure that the entrance angle is fixed until an impact test at the angle is completed. Meanwhile, the rotating support seat 1 is preferably welded through a beam-type material of aluminum alloy (carbon steel).

In the system, the disposable low-strength sealing thermal insulation film 74 is used to greatly reduce heat/moisture exchange between an interior of the chamber body of the rapid cooling environmental chamber and an external environment, and ensures stability of the test environment, thus improving test accuracy and greatly reducing test refrigeration cost. Specifically, the impact object entrance door 7 is provided with the adjustable-position sliding mechanism 71. Left and right sides of the adjustable-position sliding mechanism 71 are connected to stretchable parts 711. The adjustable-position sliding mechanism 71 is provided with the disposable low-strength sealing thermal insulation film 74. The impact object entrance port 75 is located in a zone of the disposable low-strength sealing thermal insulation film. The design causes a position of the impact object entrance port 75 to be flexibly adjusted according to an impact angle, such that sealing and thermal insulation of the chamber body 3 are implemented, and meanwhile, energy loss caused by impact of the foreign object and secondary damage of chips to the to-be-tested component are minimized.

Preferably, the stretchable parts 711 are corrugated origami structures made of flexible thermal insulation materials. The adjustable-position sliding mechanism 71 is provided with the disposable low-strength sealing thermal insulation film 74. The impact object entrance port 75 is located in the zone of the disposable low-strength sealing thermal insulation film 74.

Preferably, a sliding range of the stretchable parts 711 of the adjustable-position sliding mechanism 71 is from a center of an entrance wall surface to edges of the stretchable parts 711, such that a position requirement for the impact object entrance port during deflected-angle entrance is satisfied. In order to satisfy impact position requirements at different entrance angles, specifically, the moving distance of the impact object entrance port 75 is

$$L = \frac{H}{tan θ} .$$

H denotes a minimum perpendicular distance from an impact point position of the to-be-tested component to a plane of the impact object entrance port 75, and θ denotes an entrance angle.

Preferably, the disposable low-strength sealing thermal insulation film 74 is made of a flexible material and is bonded to the impact object entrance port 75 through glue. A thickness of the disposable low-strength sealing thermal insulation film 74 is 0.1 mm to 2 mm. A film material has breaking strength not higher than 0.1 MPa and an elongation not greater than 10%. Under the above conditions, it can be ensured that the to-be-tested component 9 can smoothly penetrate the disposable low-strength sealing thermal insulation film 74, and that a thermal insulation requirement of a cooling environment in the chamber body 3 and the outside can be ensured. In addition, an entrance impact object can quickly pass through the impact object entrance port 75 without speed attenuation and running posture change. The disposable low-strength sealing thermal insulation film 74 not only implements sealing and thermal insulation of the rapid cooling environmental chamber, but also minimizes energy loss of the entrance impact object and secondary damage of chips to the to-be-tested component 9. Meanwhile, the disposable low-strength sealing thermal insulation film 74 is provided with the cross-shaped center mark, facilitating alignment and checking of the entrance impact object, the impact object entrance port 75, and an entrance point before the test, and assisting the impact point position of the to-be-tested component 9 in aiming and alignment with the entrance point of the foreign object of the impact. An inner wall surface of the impact object entrance door 7 is provided with an inclined high-speed camera mounting hole 73 configured to mount the high-speed camera 600. In addition, a laminated tempering glass protective cover is mounted at a lens position.

The temperature and humidity data of the to-be-tested component 9 and temperature and humidity data of the environment in the chamber body are coupled to be monitored, such that a state of the environment in the rapid cooling environmental chamber is more accurately regulated and controlled, and a state of the to-be-tested component is ensured to be true and effective. The environmental temperature and humidity sensor 72 on the inner wall of the chamber body 3 and the to-be-tested component temperature and humidity sensors 91 in the to-be-tested component 9 synchronously monitor and control the temperatures and humidities of the chamber body and the to-be-tested component, such that local deformation or even failure caused by an excessive temperature difference in the to-be-tested component due to an excessive cooling rate can be prevented, thus ensuring impact resistance of the to-be-tested component in a true and uniform low-temperature state.

In addition, the test system integrates a launching system with various external monitoring apparatuses, which can implement millisecond-class collection immediately after triggering, thus ensuring consistency of a data time dimension, and reducing data processing errors. The test system can implement the test environment of −150° C. and satisfy test requirements of materials and components in various fields in an extremely cold environment. Through the cooperation of the above structure and control and monitoring systems, the present disclosure can implement a multi-angle, high-precision and high-reliability high-speed impact test in the low-temperature environment.

Optionally, the chamber body 3 is generally in a cuboid (cube) shape, uses a beam-type material as the framework 32 and sheet metal as a surface skin, and is made through a welding/riveting process. Its main material is a metal material such as aluminum alloy or carbon steel. In this way, bearing capacity and impact resistance of the structure of the chamber body 3 are ensured.

Preferably, in order to satisfy a thermal insulation requirement, the wall surface 31 of the chamber body 3 is the sandwich thermal insulation wall surface composed of high-strength aluminum alloy (carbon steel) and the thermal insulation material. In this way, a structural strength requirement of the chamber body 3 is satisfied, and a thermal insulation effect required by the test environment can be achieved. The chamber body 3 is provided with a high-speed camera observation port 4.

Preferably, the chamber body 3 is internally provided with a special illumination device, a plurality of wall surfaces of the chamber body 3, such as the entrance wall surface, a side wall surface and a back wall surface, are prefabricated with special mounting connectors for high-speed cameras, and a laminated tempering glass protective cover is mounted at a lens position, such that an observation requirement in a test process is satisfied. The rapid cooling environmental chamber is provided with a flexible airtight wire slot hole, facilitating passing of all kinds of sensor data collection transmission lines.

FIG. 3 is a schematic structural diagram of a rapid cooling environmental chamber in another state in an embodiment of the present disclosure.

As shown in FIG. 3, in combination with FIG. 1 and FIG. 2, the embodiment further shows a specific structure of a rapid cooling environmental chamber 100 in an angle adjustment state. A rotating support seat 1 rotates relative to a fixed end 12 through a rotating end 11, so as to change an overall rotation angle of a chamber body 3. A range of the rotation angle is accurately controlled between 0° and 75° through an angle scaleplate 15. In this way, impact working conditions in different entrance directions in practical application are simulated. The fixed end 12 of the rotating support seat 1 is fixed to the ground through a bolt, and the rotating end 11 is carried by a universal wheel 13, such that smooth rotation is facilitated. A central hinge pin is provided with a bolt fastening apparatus 14. The bolt fastening apparatus may be locked to fix a posture of the chamber body 3 after rotation by a predetermined angle. An adjustable-position sliding mechanism 71 of an impact object entrance door 7 and stretchable parts 711 at left and right sides of the adjustable-position sliding mechanism work cooperatively. When the chamber body 3 is inclined, through horizontal movement of the adjustable-position sliding mechanism 71 and flexible expansion and contraction of the stretchable parts 711, an impact object entrance port 75 is kept accurately aligned with an outlet of a barrel 303 all the time, so as to ensure accurate entrance of an impact object at a predetermined angle and position. An illumination device 5 on an inner wall of the chamber body 3 provides sufficient illumination for a high-speed camera 600, to ensure clarity of shot pictures. A protective glass cover 41 is mounted on a high-speed camera observation port 4, and facilitates observation and protection. A liquid nitrogen condensation pipe 6 is uniformly laid in an S-shape on a wall surface 31 of the chamber body 3, and is connected to a self-pressurizing liquid nitrogen tank 200 through a liquid nitrogen condensation pipe main connector 61, such that efficient conveying and rapid cooling of liquid nitrogen are implemented. An environmental temperature and humidity sensor 72 monitors a state of an environment in the rapid cooling environmental chamber in real time, and is connected to an external temperature and humidity processing unit through a collection harness connector 33, such that closed-loop temperature control and regulation are implemented.

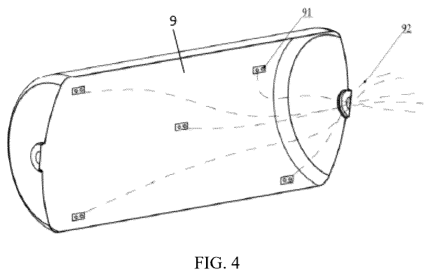

FIG. 4 is a schematic structural diagram of a to-be-tested component in an embodiment of the present disclosure.

As shown in FIG. 4, in combination with FIG. 1 and FIG. 2, the embodiment further shows a mounting and sensor arrangement structure of a to-be-tested component 9. The to-be-tested component 9 is fixedly mounted in a chamber body 3 through a to-be-tested component fixed mounting fixture 8. Specifically, the to-be-tested component may be a key component such as a vehicle body plate or a bogie component of a rail vehicle. A plurality of to-be-tested component temperature and humidity sensors 91 (with a quantity not less than 4) are embedded in the to-be-tested component 9. The sensors are uniformly distributed at different positions (such as a center, an edge, and a position near an impact point) of the to-be-tested component, and connected to a collection harness connector 33 on a wall surface of the chamber body through a collection harness 92, so as to monitor temperature and humidity distributions of the to-be-tested component in a real-time, multi-point and multi-dimension manner. A strain gauge may be bonded to the position near the impact point orthogonally in a circumferential direction, to collect a strain response at the moment of impact. A high-speed camera 600 mounted on an inner wall of the chamber body 3 may record an impact process and a damage shape in all directions through high-speed camera observation ports 4 at different positions (such as facing an impact surface or side surface). A humidity regulator 10 is mounted on the inner wall of the chamber body 3, and may actively regulate a humidity in the rapid cooling environmental chamber according to test requirements, so as to ensure accurate control of environmental temperature and humidity conditions. After an impact object entrance door 7 is closed, an additional high-speed camera may be mounted in an inclined high-speed camera mounting hole 73 on an inner wall of the impact object entrance door, so as to additionally record an impact object entrance and to-be-tested component back response process. Data of an environmental temperature and humidity sensor 72 and the to-be-tested component temperature and humidity sensors 91 is compared and analyzed, such that it can be ensured that the to-be-tested component completely reaches a low-temperature stable state consistent with a set environment before impact, which can truly reflect impact resistance of a material or component in an extremely-low-temperature environment.

Based on the structure shown in FIG. 1 to FIG. 4, specifically, when a high-speed impact test on a rail vehicle component is performed in a low-temperature environment, the chamber body 3 is fixed to an impacted side of the test system for high-speed impact of a foreign object on a rail vehicle component in a low-temperature environment through a rotating support seat 1, with a distance of 3 m to 5 m from an end of a launching pipe. The impacted rail vehicle component is clamped at a mounting position of the to-be-tested component in the chamber body 3. Data collection sensors, such as a strain gauge and a displacement meter, are arranged on the impacted component, and a collection harness is connected to a data collection system through a flexible airtight wire slot hole. The impact object entrance door 7 is closed and locked, the adjustable-position sliding mechanism 71 is adjusted to align the launching pipe with a to-be-impacted position of the component, an impact angle is adjusted through the rotating support seat 1, and a universal wheel 13 is locked. A high-speed camera is mounted on the wall surface of the chamber body 3 and is connected to the strain collection system. An illumination device in the chamber body 3 is turned on, and a collection picture size and parameters are adjusted. A liquid nitrogen condensation pipe 6 of the chamber body 3 is connected to a self-pressurizing liquid nitrogen tank 200 through a conveying pipe, the temperature of the environment in the chamber body is set, an intelligent liquid nitrogen flow control valve is opened, and a liquid nitrogen flow amount is controlled in real time according to the temperature until the temperature reaches a predetermined temperature and is kept basically consistent throughout the test.

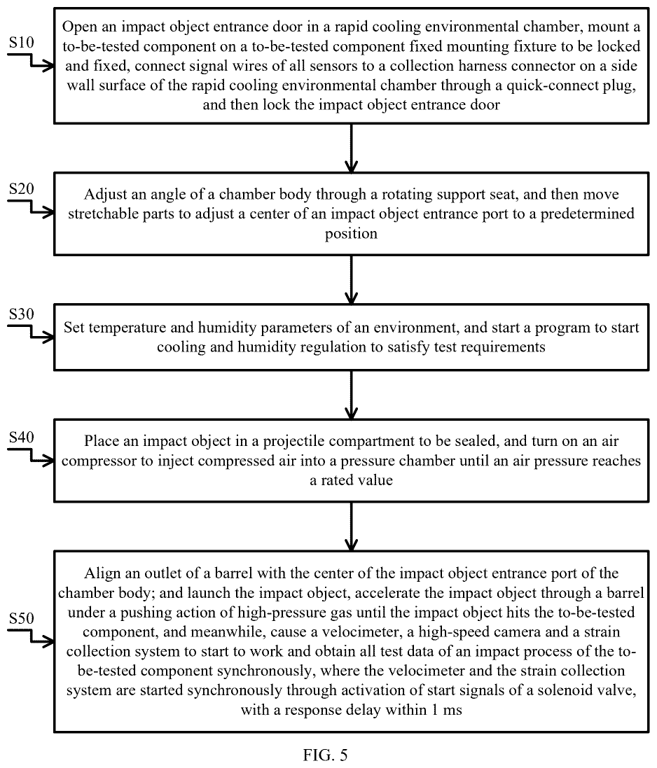

FIG. 5 is a flowchart of a test method for high-speed impact of a foreign object on a rail vehicle component in a low-temperature environment in an embodiment of the present disclosure.

As shown in FIG. 5, in combination with FIG. 1 to FIG. 4, based on the same inventive concept, the present disclosure further provides a test method for high-speed impact of a foreign object on a rail vehicle component in a low-temperature environment, which uses the above test system for high-speed impact of a foreign object on a rail vehicle component in a low-temperature environment. The test method includes the following steps:
S10, an impact object entrance door 7 in a rapid cooling environmental chamber 100 is opened, a to-be-tested component 9 is mounted on a to-be-tested component fixed mounting fixture 8 to be locked and fixed, signal wires of all sensors are connected to a collection harness connector 33 on a side wall surface of the rapid cooling environmental chamber through a quick-connect plug, and then the impact object entrance door 7 is locked.
S20, an angle of a chamber body 3 is adjusted through a rotating support seat 1, and then stretchable parts 711 are moved to adjust a center of an impact object entrance port 75 to a predetermined position.

Specifically, a bolt fastening apparatus 14 on a central hinge pin of the rotating support seat 1 is opened, and an angle (in a range of 0° to) 75° of a rotating end of the rotating support seat 1 is adjusted, such that a scale of an angle marking line on a scaleplate is caused to be consistent with an entrance angle, and the bolt fastening apparatus 14 is locked. Then, a position of the impact object entrance port 75 of the impact object entrance door 7 is moved by a moving distance

$$L = \frac{H}{tan θ}$$

(where H denotes a perpendicular distance from an impact point position of the to-be-tested component to a plane of the impact object entrance port 75, and θ denotes the entrance angle), such that a cross-shaped center mark on a disposable low-strength sealing thermal insulation film 74 is aligned with aiming laser of a barrel 303. The stretchable parts 711 are moved to adjust the center of the impact object entrance port 75 to the predetermined position.

Specifically, the stretchable parts 711 on the rapid cooling environmental chamber 100 are moved to cause a marking line of the center of the impact object entrance port 75 to be located at a scale position “0”.

Preferably, the to-be-tested component 9 and an impact object are placed in the rapid cooling environmental chamber 100 24 hours before a test and cooled to a test temperature.

S30, temperature and humidity parameters of an environment are set, and a program is started to start cooling and humidity regulation to satisfy test requirements.

Specifically, a temperature and humidity processing unit 102 sets a temperature and humidity of the rapid cooling environmental chamber 100, and starts the program to start cooling and humidity regulation. A display module displays temperatures and humidities of the environment and the to-be-tested component 9 in real time, and the program of the temperature and humidity processing unit controls a maximum temperature difference and a maximum humidity percentage difference between the to-be-tested component and the environment in the rapid cooling environmental chamber to be less than or equal to 10° C. and 10% respectively before a predetermined stable test temperature and humidity are not reached (a cooling stage). When the temperature and humidity in the rapid cooling environmental chamber 100 reach a predetermined temperature value (with an error ±1° C.) and a predetermined humidity value (with an error 1%) and a temperature error and a humidity error between the to-be-tested component 9 and the rapid cooling environmental chamber 100 are ±1° C. and 2% respectively, it is determined that the temperature and humidity of the to-be-tested component are consistent with those of the environment, and the test requirements are satisfied.

S40, an impact object is placed in a projectile compartment 302 to be sealed, and an air compressor 301 is turned on to inject compressed air into a pressure chamber until an air pressure reaches a rated value.

Specifically, the impact object is placed in a separable projectile holder. Then, the separable projectile holder is placed in the projectile compartment 302, and a cover plate is locked for sealing. The air compressor 301 is turned on to inject compressed air into the pressure chamber until the air pressure reaches the rated value.

S50, an outlet of the barrel 303 is aligned with the center of the impact object entrance port 75 of the chamber body 3; and the impact object is launched, the impact object is accelerated through the barrel 303 under a pushing action of high-pressure gas until the impact object hits the to-be-tested component 9, and meanwhile, a velocimeter 400, a high-speed camera 600 and a strain collection system 500 are caused to start to work and obtain all test data of an impact process of the to-be-tested component 9 synchronously. The velocimeter 400 and the strain collection system 500 are started synchronously through activation of start signals of a solenoid valve, with a response delay within 1 ms.

Specifically, the outlet of the barrel 303 is aligned with the center of the impact object entrance port 75 of the chamber body 3. The solenoid valve is turned on. The impact object is accelerated through the barrel 303 under the pushing action of the high-pressure gas until the impact object hits the to-be-tested component 9. Meanwhile, the velocimeter 400, the high-speed camera 600, the strain collection system 500 and an auxiliary detection system are caused to start to work through activation of the start signals of the solenoid valve, and obtain all the test data of the impact process of the to-be-tested component 9 synchronously. The velocimeter 400, the strain collection system 500 and the high-speed camera 600 are started synchronously through activation of the start signals of the solenoid valve. The response delay is within 1 ms.

Preferably, after the high-speed impact test of the to-be-tested component 9 is completed, the to-be-tested component 9 is taken out by opening the impact object entrance door 7, and the disposable low-strength sealing thermal insulation film 74 is replaced for a next impact test later.

It should be understood that the above specific implementations of the present disclosure are merely used to illustrate or explain principles of the present disclosure, and do not limit the present disclosure. Thus, any modification, equivalent substitution, improvement, etc. made without departing from the spirit and scope of the present disclosure shall fall within the protection scope of the present disclosure. In addition, the append claims of the present disclosure are intended to cover all changes and modifications falling within the scope and boundary of the appended claims, or equivalents of the scope and boundary.

What is claimed is:

1. A test system for high-speed impact of a foreign object on a rail vehicle component in a low-temperature environment, comprising:
a rapid cooling environmental chamber, configured to provide a low-temperature test environment and accommodate a to-be-tested component, wherein one side surface of the rapid cooling environmental chamber is provided with an openable and closable impact object entrance door, a liquid nitrogen condensation pipe is laid on inner walls of the other side surfaces of the rapid cooling environmental chamber, and the impact object entrance door is provided with an impact object entrance port;
a self-pressurizing liquid nitrogen tank, connected to the liquid nitrogen condensation pipe through a conveying pipeline, and configured to provide a cooling medium for the rapid cooling environmental chamber;
a high-pressure air cannon system, configured to provide a power source for an impact object, comprising an air cannon, an air compressor connected to the air cannon, a projectile compartment arranged on the air cannon, and a barrel connected to the projectile compartment, wherein one end of an outlet of the barrel is provided with a velocimeter, and during use, the outlet of the barrel is configured to be aligned with the impact object entrance port;
a strain collection system, configured to collect a strain response of an impact zone, comprising a high-speed camera, an environmental temperature and humidity sensor, and to-be-tested component temperature and humidity sensors, wherein the high-speed camera is mounted on a pre-mounted connector on a wall surface of the rapid cooling environmental chamber, and configured to capture an impact process; the to-be-tested component temperature and humidity sensors are embedded in the to-be-tested component, and configured to monitor temperature and humidity parameters of the to-be-tested component; and the environmental temperature and humidity sensor is arranged in the rapid cooling environmental chamber, and configured to monitor temperature and humidity parameters in the rapid cooling environmental chamber; and
a microcomputer system, connected to the strain collection system in a communicating manner, and configured to perform centralized processing, storage and analysis on data collected by the strain collection system, and control the high-pressure air cannon system, the rapid cooling environmental chamber and the self-pressurizing liquid nitrogen tank to work cooperatively, so as to complete a complete test flow from environmental cooling and impact launching to data collecting.

2. The test system according to claim 1, wherein the rapid cooling environmental chamber comprises:
a chamber body, comprising a framework and a sandwich thermal insulation wall surface formed by a high-strength aluminum alloy plate and a thermal insulation material, wherein an inner wall of the chamber body is provided with a to-be-tested component fixed mounting fixture and a humidity regulator; and
a rotating support seat, arranged at a bottom of the chamber body, and configured to adjust a rotation angle of the chamber body, wherein the rotating support seat comprises a fixed end and a rotating end, the fixed end is hinged to the rotating end, and the rotating end is locked after rotating by a predetermined angle.

3. The test system according to claim 2, wherein
the impact object entrance door is movably connected to the framework, the chamber body is sealed when the impact object entrance door is closed, and the to-be-tested component is placed in the chamber body after the impact object entrance door is opened;
the impact object entrance door is provided with an adjustable-position sliding mechanism, left and right sides of the adjustable-position sliding mechanism are connected to stretchable parts, the adjustable-position sliding mechanism is provided with a disposable low-strength sealing thermal insulation film, and the impact object entrance port is located in a zone of the disposable low-strength sealing thermal insulation film; and
a moving distance of the impact object entrance port is
$$L = \frac{H}{tan θ} ,$$
wherein H denotes a perpendicular distance from an impact point position of the to-be-tested component to a plane of the impact object entrance port, and 0 denotes an entrance angle.

4. The test system according to claim 2, wherein
the rotating support seat further comprises a central hinge pin, the fixed end is hinged to the rotating end through the central hinge pin, a rotational degree of freedom of the rotating end is 0° to 75°, and the rotating end is carried by a universal wheel; and
the central hinge pin is provided with a bolt fastening apparatus, and the bolt fastening apparatus is configured to lock the rotating end; and the central hinge pin is provided with an angle scaleplate.

5. The test system according to claim 3, wherein
the disposable low-strength sealing thermal insulation film is made of a flexible material, and is bonded to the impact object entrance port through glue, a thickness of the disposable low-strength sealing thermal insulation film is 0.1 mm to 2 mm, the material has breaking strength not higher than 0.1 MPa and an elongation not greater than 10%, and the disposable low-strength sealing thermal insulation film is provided with a cross-shaped center mark; and
the stretchable parts are corrugated origami structures made of flexible thermal insulation materials.

6. The test system according to claim 2, wherein
an inner wall surface of the chamber body is provided with a collection harness connector configured to connect the environmental temperature and humidity sensor, a strain gauge, and an auxiliary test sensor;
the collection harness connector is externally connected to a temperature and humidity processing unit, and the temperature and humidity processing unit is connected to the environmental temperature and humidity sensor and the to-be-tested component temperature and humidity sensors, and is configured to monitor a temperature and humidity difference between an environment in the chamber body and the to-be-tested component;
an outlet of the self-pressurizing liquid nitrogen tank is provided with an intelligent liquid nitrogen flow control valve, and a liquid nitrogen flow amount is regulated in real time by receiving temperature data of the temperature and humidity processing unit;
when a temperature difference and a humidity difference between the environment in the chamber body and the to-be-tested component are ±1° C. and 2%, respectively, it is determined that a temperature and humidity of the to-be-tested component are consistent with those of the environment; and
in a cooling process, a maximum temperature difference and a maximum humidity percentage difference between the to-be-tested component and the environment in the chamber body are less than 10° C. and 10%, respectively.

7. The test system according to claim 1, wherein a quantity of the to-be-tested component temperature and humidity sensors is not less than 4, the to-be-tested component temperature and humidity sensors are arranged at different positions of the to-be-tested component, respectively, and if a relative error of temperature and humidity data monitored at different positions is within 2%, it is determined that the to-be-tested component reaches a stable test state.

8. The test system according to claim 1, wherein
a barrel liquid nitrogen condensation pipe is spirally wound around an outer surface of the barrel of the high-pressure air cannon system, and the barrel liquid nitrogen condensation pipe is connected to the self-pressurizing liquid nitrogen tank; and
the outer surface of the barrel is provided with a pipeline temperature and humidity sensor, and the pipeline temperature and humidity sensor makes no direct contact with the barrel liquid nitrogen condensation pipe.

9. The test system according to claim 1, wherein
the barrel of the high-pressure air cannon system and the impact object are mounted in a matched manner through a separable projectile holder, and the separable projectile holder has a shape of 4 to 6 equal petals, an outer contour in clearance fit with an interior of the barrel, and a fit tolerance of 0.1 mm to 0.3 mm; and
the separable projectile holder is made of a light foaming material, and has a mass less than 20 g.

10. A test method for high-speed impact of a foreign object on a rail vehicle component in a low-temperature environment, using the test system according to claim 6, and comprising the following steps:
opening an impact object entrance door in a rapid cooling environmental chamber, mounting a to-be-tested component on a to-be-tested component fixed mounting fixture to be locked and fixed, connecting signal wires of all sensors to a collection harness connector on a side wall surface of the rapid cooling environmental chamber, and then locking the impact object entrance door;
adjusting an angle of a chamber body through a rotating support seat, and then moving stretchable parts to adjust a center of an impact object entrance port to a predetermined position;
setting temperature and humidity parameters of an environment, and starting a cooling and humidity regulation program to satisfy test requirements;
placing an impact object in a projectile compartment to be sealed, and turning on an air compressor to inject compressed air into a pressure chamber until an air pressure reaches a rated value; and
aligning an outlet of the barrel with the center of the impact object entrance port of the chamber body; and launching the impact object, accelerating the impact object through a barrel under a pushing action of high-pressure gas until the impact object hits the to-be-tested component, and meanwhile, causing a velocimeter and a strain collection system to start to work and obtain all test data of an impact process of the to-be-tested component synchronously, wherein the velocimeter and the strain collection system are started synchronously through activation of start signals of a solenoid valve, with a response delay within 1 ms.
